(19) United States
(12) Patent Application Publication
(10) Pub. No.: US 2014/0091780 A1
(43) Pub. Date: Apr. 3, 2014

(54) REFERENCE VOLTAGE GENERATOR

(71) Applicant: Novatek Microelectronics Corp., Hsinchu (TW)

(72) Inventors: Min-Hung Hu, Hsinchu City (TW); Chiu-Huang Huang, Hsinchu County (TW); Chen-Tsung Wu, Kaohsiung City (TW); Juin-Wei Huang, Hsinchu County (TW); Pin-Han Su, Taichung City (TW)

(21) Appl. No.: 13/928,346

(22) Filed: Jun. 26, 2013

(30) Foreign Application Priority Data
Sep. 28, 2012 (TW) 101136000

(51) Int. Cl. G05F 1/46

(52) U.S. Cl. CPC G05F 1/462
USPC 323/314

(57) ABSTRACT

A reference voltage generator including a reference voltage generating unit is provided. The reference voltage generating unit receives a first bias voltage current and a first mirror current and generates a reference voltage. The reference voltage generating unit includes a first metal-oxide-semiconductor (MOS) transistor, a second MOS transistor, a first impedance providing element and a second impedance providing element. The first and the second MOS transistors operate in a sub-threshold region so as to generate a first gate-source voltage and a second gate-source voltage having a negative temperature coefficient. The first impedance providing element is configured to generate a first current having a positive temperature coefficient. The second impedance providing element is configured to generate a first voltage having a negative temperature coefficient at its first terminal. The reference voltage is equal to a sum of the second gate-source voltage and the first voltage.

### CROSS-REFERENCE TO RELATED APPLICATION

This application claims the priority benefit of Taiwan application serial no. 101136000, filed on Sep. 28, 2012. The entirety of the above-mentioned patent application is hereby incorporated by reference herein and made a part of this specification.

### BACKGROUND OF THE DISCLOSURE

1. Field of the Disclosure

The disclosure is related to a reference voltage generator, and particularly a reference voltage generator employing metal-oxide semiconductor transistors as main components.

2. Description of the Related Art

A digital-to-analog converter (DAC), an analog-to-digital converter (ADC), or a regulator requires at least a reference voltage that is fixed and constant. It is best that the reference voltage is regenerated for every power-up with stability. An ideal reference voltage is not to be affected by the fabrication variation, changes in operational temperature, and variations in power source. The bandgap reference circuit plays an important role in many electronic systems due to its ability to provide a reference voltage having better stability and accuracy.

Brokaw disclosed a bandgap reference circuit in U.S. Pat. No. 4,250,445. With reference to FIG. 1A, FIG. 1A is a circuit diagram illustrating the bandgap reference circuit disclosed by Brokaw. The bandgap reference circuit 10 includes an operational transconductance amplifier (OTA) 11, two bipolar junction transistors (BJT) Q1 and Q2, and resistors repeatedly arranged in a cascode configuration (e.g., R_{C1}, R_{C2}, R, and R_{L}). By a specific ratio 1:K of the area of BJT transistors Q1 and Q2 and a current I_{E1} having a positive temperature coefficient generated by the resistor R, a voltage Vp having a positive temperature coefficient can be generated by the current I_{E1} flowing into the resistor R_{L}. After the voltage Vp is superimposed with a voltage V_{BE2} having a negative temperature coefficient of the BJT transistor Q1, a base of BJT transistor Q1 outputs a reference voltage V_{REF} that is close to zero temperature coefficient.

The bandgap reference circuit 10 latches the voltages V_{IN+} and V_{IN-} of two input terminals by the OTA 11. Since the voltage V_{IN+} equals to the voltage V_{IN-}, the resistors Rc1 and Rc2 have identical currents. Therefore, current I_{E1}=(V_{BE2}−V_{BE1})/R=V_{T} ln(K)L/R and has a positive temperature coefficient, where V_{T} is a thermal voltage and ratio of resistor L=2R_{L}/R. The voltage V_{BE2} of the BJT transistor Q2 has a negative temperature coefficient, so the output reference voltage V_{REF}=V_{BE2}+2×I_{E1}×R_{L}=V_{BE2}+V_{T} ln(K)L. Therefore, the reference voltage V_{REF} can be a voltage having temperature coefficient that is close to zero temperature coefficient by adjusting the ratio of resistor L.

The advantage of the bandgap reference circuit 10 is a better immunity against noise and ability to operate with a system voltage VDD that is lower than the system voltage of a typical bandgap reference circuit. Since, the output reference voltage V_{REF} is a voltage \Tₒᵤᵣ at an output terminal of the OTA 11, the noise in the system can be suppressed through a negative feedback formed by the OTA 11, such that a better power supply rejection ratio (PSRR) is provided. The operational condition of the bandgap reference circuit is the system voltage VDD≧V_{REF}+V_{DS}≈1.2V+0.2V=1.4V, which is lower than the system voltage of a typical bandgap reference circuit.

However, the bandgap reference circuit 10 is not suitable for some applications that require a lower system voltage VDD. Furthermore, the bandgap reference circuit 10 utilizes the BJT transistors Q1 and Q2 as amplifiers. Under the condition that only the parasitic BJT transistors are available in the fabrication of the complementary metal-oxide semiconductor (CMOS), in addition to more layout area are occupied, the characteristic of the elements is poor. Moreover, the loop-gain of the base current of the BJT transistors decreases and affecting the high-frequency characteristic as well as the drifting of the voltage due to the temperature.

In addition, the bandgap reference circuit is required to provide a reference current having a zero temperature coefficient for certain applications. However, this circuit can solely provide a reference voltage having the zero temperature coefficient, and additional circuits are required to generate the reference current that is desired.

In U.S. publication application No. 2011/0062938, Riehl disclosed another bandgap reference circuit. FIG. 1B is a circuit diagram illustrating a bandgap reference circuit disclosed by Riehl. With reference to FIG. 1A and FIG. 1B, the difference between the bandgap reference circuit 10 of Brokaw and Riehl is that, the bandgap reference circuit 20 of Riehl directly utilizes the BJT transistors Q1 and Q2 as an input-pair of the OTA 21, and further utilizes a P-channel metal-oxide semiconductor transistor MP1 as an output stage so as to latch the output voltage V_{REF}. As such, the bandgap reference circuit of Brokaw can be reduced and simplified, and a better PSRR is provided.

However, such circuit configuration requires the operational system voltage VDD of the bandgap reference circuit 20 to be increased, that is the system voltage VDD≧V_{T} ln(K)L+V_{CE}+V_{GS}≈0.6V+0.2V+0.8V=1.6V, where V_{CE} is a collector-emitter voltage across the BJT transistors Q1 and Q2, V_{GS} is a gate-source voltage of a P-channel MOS transistor MP. Therefore, the operational system voltage VDD of the bandgap reference circuit 20 is higher than the operational system voltage of the bandgap reference circuit 10 of Brokaw. In addition, the bandgap reference circuit 20 also utilizes the BJT transistors Q1 and Q2 as amplifiers and as an input-pair of the OTA 21, therefore, the bandgap reference circuit 20 also has the same disadvantages as the configuration of Brokaw described in FIG. 1A.

In Electronics Letters, p 572-p 573, Vol. 41 Issue 10, a thesis, entitled “Low-power low-voltage reference using peaking current mirror circuit”, disclosed yet another bandgap reference circuit. With reference to FIG. 1C, FIG. 1C is a circuit diagram illustrating the bandgap reference circuit disclosed by the above-identified thesis. As described above, in order to simplify the bandgap reference circuit and avoid an excessive layout area occupied by the typical bandgap reference circuit that utilizes the BJT transistors, a bandgap reference circuit 30 of FIG. 1C replaces the BJT transistors Q1 and Q2 in FIG. 1A or 1B with two N-channel MOS transistors Mn1 and Mn2 that operates in a sub-threshold region, and collocate with a current mirror unit 31 having a simplified configuration, so as to generate the reference voltage V_{REF}. The operational condition of the bandgap reference circuit 30 is to have a system voltage VDD≧V_{REF}±V_{DS}≈1.2V+0.2V=1.4V, where V_{DS} is the drain-source voltage of a P-channel MOS transistor Mp2.

When the N-channel MOS transistors Mn1 and Mn2 operates in the sub-threshold region, there is a index relationship between a current I_{D} and the N-channel MOS transistors Mn1 and Mn2, which may be represented as

$${I}_{D} = \frac{W}{L} \cdot {I}_{DO} \cdot {e}^{\frac{{V}_{GS}}{{nV}_{T}}} ,$$

where V_{GS} is a gate-source voltage of the N-channel MOS transistor Mn1 and Mn2. Furthermore, the bandgap reference voltage 30 generates a current having a positive temperature coefficient that is similar to the BJT transistors Q1 and Q2 in FIG. 1A or FIG. 1B, where I_{D}=(V_{GS2}−V_{GS1})R=V_{T} ln(K)/R. Since a gate-source voltage V_{GS2} of the N-channel MOS transistor Mn2 has a negative temperature coefficient, the reference voltage V_{REF} having a temperature coefficient close to zero temperature coefficient that is similar to the BJT transistors Q1 and Q2 may be obtained, and the reference voltage can be represented as V_{REF}=V_{GS2}+2×I_{D}×R_{L}=V_{GS2}+V_{T} ln(K)L.

As described above, the advantages of utilizing the N-channel MOS transistors Mn1 and Mn2 instead of BJT transistors Q1 and Q2 is that the layout area of the components can be reduced and have better component characteristics. However, the linearity of the temperature coefficient of the gate-source voltage V_{GS1} and V_{GS2} of the N-channel MOS transistors Mn1 and Mn2 are poor and easily drifted along with fabrication, the output reference voltage V_{REF} still changes in certain degree along with temperature.

By comparing FIG. 1A and FIG. 1B, Brokaw's bandgap reference circuits 10 and 20 have ability to suppress noise, however the bandgap reference circuit 30 does not have the OTA 11 and 12 of Brokaw's bandgap reference circuit to suppress noise with the system by a mean of negative feedback. Therefore, the PSRR of the reference voltage V_{REF} output by the bandgap reference circuit 30 is poor.

### SUMMARY OF THE DISCLOSURE

The embodiment of the disclosure set forth a reference voltage generator, which may save the layout area excessively. The reference voltage generator of the embodiment of the disclosure have good power supply rejection ratio (PSRR) with a lower system voltage as well as the capability of stabilizing a reference voltage.

The embodiment of the disclosure set forth a reference voltage generator, which includes a reference voltage generation unit. The reference voltage generation unit receives a first bias current and a first current and is configured to generate a reference voltage. The reference voltage generation unit includes a first metal-oxide semiconductor (MOS) transistor, a second MOS transistor, a first impedance providing element, and a second impedance providing element. A first terminal of the first MOS transistor receives the first bias current. The first MOS transistor operates in a sub-threshold region to generate a first gate-source voltage having a negative temperature coefficient. A first terminal of the second MOS transistor receives a first mirror current, and a gate terminal of the second MOS transistor is coupled to a gate of the first MOS transistor. The second MOS transistor operates in the sub-threshold region to generate a second gate-source voltage having a negative temperature coefficient. A width-to-length ratio of the first MOS transistor is a K1 multiple of a width-to-length ratio of the second MOS transistor, where K1 is a number greater than 0 and not equal to 1. A first terminal of the first impedance providing element is coupled to a second terminal of the first MOS transistor, and a second terminal of the first impedance providing element is coupled to the second terminal of the second MOS transistor, where the first impedance providing element is configured to generate a first current having a positive temperature coefficient. A first terminal of the second impedance element is coupled to the second terminal of the second MOS transistor, and a second terminal of the second MOS transistor is coupled to a ground voltage, where the second impedance providing element is configured to generate a first voltage having a positive temperature coefficient at the first terminal of the second impedance providing element. The reference voltage equals to the second gate-source voltage plus the first voltage.

In an embodiment of the disclosure, the reference voltage generation unit further includes a current mirror unit, which is electrically connected to the reference voltage generation unit. The current mirror unit is configured to provide the first bias current and the first mirror current. The current mirror unit mirrors the first bias current to generate the first mirror current.

In an embodiment of the disclosure, the current mirror unit includes a third transistor, a fourth transistor, a fifth transistor, a sixth transistor, a seventh transistor, and an eighth transistor. A first terminal of the third transistor is coupled to the system voltage, a second terminal is coupled to the first terminal of the second MOS transistor. The fourth transistor has a first terminal coupled to the system voltage, a gate terminal coupled to a gate terminal of the third transistor, and a second terminal coupled to the first terminal of the first MOS transistor. The fifth transistor has a first terminal coupled to the second terminal of the third transistor, a gate terminal that receives the first bias voltage, and a second terminal coupled to the gate of the third transistor. The sixth transistor has a first terminal coupled to the second terminal of the fourth transistor, and a gate terminal that receives the first bias voltage. The seventh transistor has a first terminal coupled to the second terminal of the fifth transistor, a gate terminal that receives the second bias voltage, and a second terminal coupled to the ground voltage. The eighth transistor has a first terminal coupled to a second terminal of the sixth transistor, a gate terminal that receives the second bias voltage, and a second terminal coupled to the ground voltage.

In an embodiment of the disclosure, the reference voltage generator further includes an output stage unit, which is coupled to the reference voltage generation unit and the current mirror unit. The output stage unit is configured to stabilize the reference voltage and generate the first reference current.

In an embodiment of the present disclosure, the output stage unit includes a ninth transistor and a voltage-to-current conversion circuit. The ninth transistor has a first terminal coupled to the system voltage, a gate terminal coupled to the second terminal of the sixth transistor, and a second terminal coupled to the gate terminal of the second MOS transistor. The ninth transistor is configured to stabilize the reference voltage. The voltage-to-current conversion circuit has a first terminal that receives the reference voltage, and a second terminal coupled to the ground voltage, where the voltage-to-current conversion circuit is configured to convert the reference voltage into a first reference current.

In an embodiment of the disclosure, the voltage-to-current conversion circuit is a third impedance providing unit, which has a first terminal that receives the reference voltage and a second terminal coupled to the ground voltage. The voltage-to-current conversion circuit is configured to generate the first reference current.

In an embodiment of the disclosure, the output stage unit further includes a voltage boosting circuit, which has a second terminal that receives the reference voltage and a first terminal coupled to the second terminal of the ninth transistor. The voltage boosting circuit is configured to boost the reference voltage into a boosted reference voltage.

In an embodiment of the disclosure, the voltage boosting circuit is a fourth impedance providing element, which has a second terminal that receives the reference voltage and a first terminal coupled to the second terminal of the ninth transistor. A resistance of the fourth impedance providing element determines the magnitude of the reference voltage to be boosted.

In an embodiment of the disclosure, the reference voltage generator further includes a voltage bucking circuit, which is electrically connected between the reference voltage generation unit and the output stage unit. The voltage bucking circuit bucks the reference voltage by extracting a portion of the first current in the reference voltage generation unit to serve as a first feedback current.

In an embodiment of the disclosure, the voltage bucking circuit includes a tenth transistor, an eleventh transistor, and a twelfth transistor. The tenth transistor has a first terminal coupled to the system voltage, a gate terminal coupled to the gate terminal of the ninth transistor, a width-to-length ratio that is an M multiple times of the width-to-length ratio of the ninth transistor. The tenth transistor is configured to mirror an M multiple of the first reference current to generate a second reference current. M is a number greater than 0, and the first reference current and the second reference current have the same temperature coefficient. The eleventh transistor has a first terminal coupled to a second terminal of the tenth transistor, a second terminal coupled to the ground voltage, and a gate terminal coupled to the second terminal of the tenth transistor. The twelfth transistor has a first terminal coupled to the first terminal of the second impedance providing element, a second terminal coupled to the ground voltage, and a gate terminal coupled to the gate terminal of the eleventh transistor. A width-to-length ratio of the twelfth transistor is an N multiple of a width-to-length ratio of the eleventh transistor. The twelfth transistor is configured to mirror an N multiple of the second reference current to generate a first feedback current, where the first feedback current is a portion of a double of the first current extracted by the twelfth transistor. N is a number greater than 0.

In an embodiment of the disclosure, the reference voltage generator further includes a temperature compensation unit, which is coupled between the reference voltage generation unit and the output unit, and configured to compensate the temperature coefficient of the reference voltage.

In an embodiment of the disclosure, the temperature compensation unit includes a thirteenth transistor and a self-bias current mirror circuit. The thirteenth transistor has a first terminal coupled to the system voltage, and a gate terminal coupled to the gate terminal of the ninth transistor, where a width-to-length ratio of the thirteenth transistor is an M multiple of a width-to-length ratio of the ninth transistor. The thirteenth transistor is configured to mirror an M multiple of the first reference current to generate a third reference current by a self-bias current mirror. The self-bias current mirror circuit is configured to generate the self-bias current having a positive temperature coefficient, and electrically connected to a second terminal of the thirteenth transistor. A second current is determined based on a lower value between the self-bias current and a half of the third reference current. The first reference current and the third reference current have the same temperature coefficient, and the third reference current and the self-bias current have different temperature coefficients.

In an embodiment of the disclosure, the temperature compensation unit further includes a fourteenth transistor. The fourteenth transistor has a first terminal coupled to the first terminal of the second impedance providing element, a second terminal coupled to the ground voltage, and a gate terminal electrically connected to the self-bias current mirror circuit. The fourteenth transistor mirrors the second current to serve as a second feedback current, and the second feedback current is a portion of a double of the first current extracted by the fourteenth transistor. The temperature coefficient curves of the third reference current and the self-bias current have a temperature cross point. When the temperature is less than the temperature cross point, the second current is the self-bias current. When the temperature is greater than the temperature cross point, the second current is half of the third reference current.

In an embodiment of the disclosure, the self-bias current mirror circuit includes a fifth transistor, a sixteenth transistor, a seventeenth transistor, an eighteenth transistor, and a fifth impedance providing element. The fifteenth transistor has a first terminal coupled to the second terminal of the thirteenth transistor. The sixteenth transistor has a first terminal coupled to the first terminal of the fifteenth transistor, a gate terminal coupled to a second terminal of the fifteenth transistor and a gate terminal of the fifteenth transistor. The seventeenth transistor has a first terminal coupled to the second terminal of the fifteenth transistor and a gate terminal of the seventeenth transistor, and a second terminal coupled to the ground voltage. A width-to-length ratio of the fourteenth transistor is an N multiple of a width-to-length ratio of the seventeenth transistor. The fourteenth transistor is configured to mirror an N multiple of the second current to serve as the second feedback current. The eighteenth transistor has a first terminal coupled to a second terminal of the sixth transistor, and a gate terminal coupled to the gate terminal of the seventeenth transistor. A width-to-length ratio of the eighteenth transistor is a K2 multiple of a width-to-length ratio of the seventeenth transistor, where K2 is a number greater than 0 and not equal to 1. The fifth impedance providing element has a first terminal coupled to a second terminal of the eighteenth transistor, and a second terminal coupled to the ground voltage. The seventeenth and the eighteenth transistors operate in a sub-threshold region, so as to generate a seventeenth gate-source voltage having a negative temperature coefficient and an eighteenth transistor having a negative temperature coefficient. The fifth impedance providing element is configured to generate the self-bias current having a positive temperature coefficient.

In the view of foregoing description, the embodiment of the disclosure set forth a reference voltage generator, which generates a first gate-source voltage and a second gate-source voltage by operating the first MOS transistor and the second MOS transistor in the sub-threshold region. In addition, a voltage drop across the two terminals of the first impedance providing element is formed by utilizing the first gate-source voltage and the second gate-source voltage, so as to generate the first current having a positive temperature coefficient. As a result, the desired reference voltage equals to the first voltage plus the second gate-source voltage. Furthermore, an excessive layout area occupied by the bipolar junction transistors can be avoided under such circuit architecture using the MOS transistor as the main components.

In order to make the aforementioned features and advantages of the present disclosure more comprehensible, several embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a circuit diagram illustrating the bandgap reference circuit disclosed by Brokaw.

FIG. 1B is a circuit diagram illustrating a bandgap reference circuit disclosed by Riehl.

FIG. 1C is a circuit diagram illustrating the bandgap reference circuit disclosed by yet another related art.

FIG. 2 is a diagram illustrating a reference voltage generator according to an embodiment of the disclosure.

FIG. 3 is a schematic diagram illustrating the circuit of a reference voltage generator 300 according to an embodiment of the disclosure.

FIG. 4 is a graphical diagram for the illustration of the reference voltage having temperature coefficient of the embodiment illustrated in FIG. 3.

FIG. 5 is a schematic diagram illustrating a reference voltage generator having a voltage boosting circuit.

FIG. 6 is a graphical diagram for the illustration of the reference voltage generator having the voltage boosting circuit of the embodiment illustrated in FIG. 5.

FIG. 7 is a system structural diagram illustrating a reference voltage generator having a voltage bucking circuit.

FIG. 8 is a circuit diagram illustrating the reference voltage generator having a voltage bucking circuit according to an embodiment of the disclosure.

FIG. 9 is a graphical diagram illustrating the reference voltage generator having the voltage bucking circuit according to the embodiment illustrated in FIG. 8.

FIG. 10 is a system structural diagram illustrating a reference voltage generator having a temperature compensation unit according to an embodiment of the disclosure.

FIG. 11 is a circuit diagram illustrating a reference voltage generator having a temperature compensation unit according to an embodiment of the disclosure.

FIG. 12 is a graphical diagram illustrating the reference voltage generator having the temperature compensation unit of the embodiment illustrated in FIG. 11.

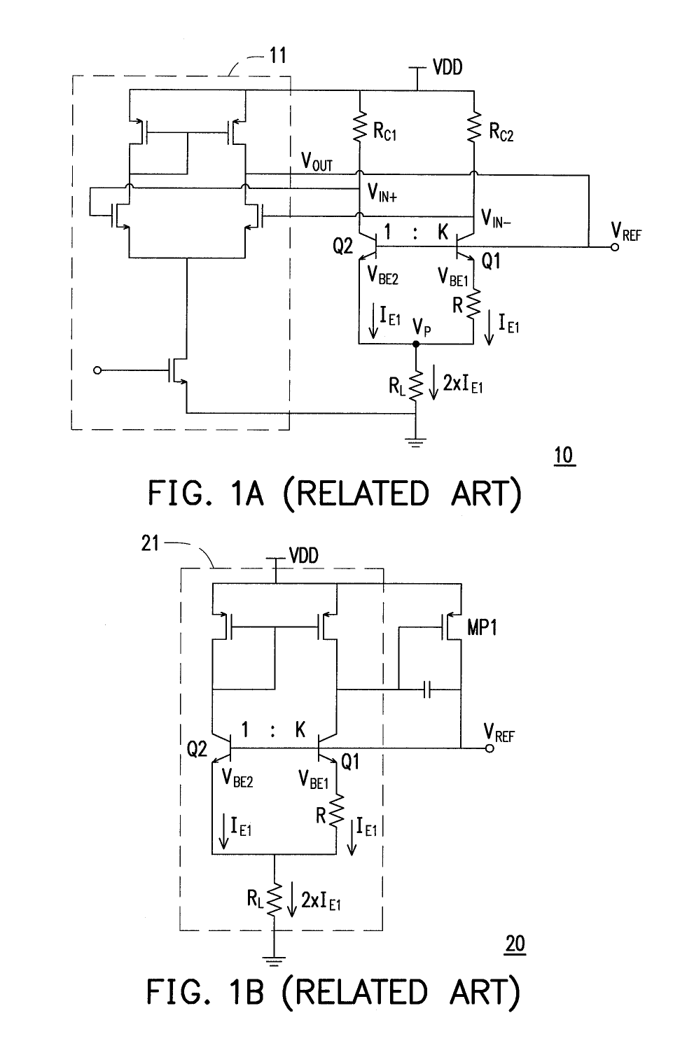

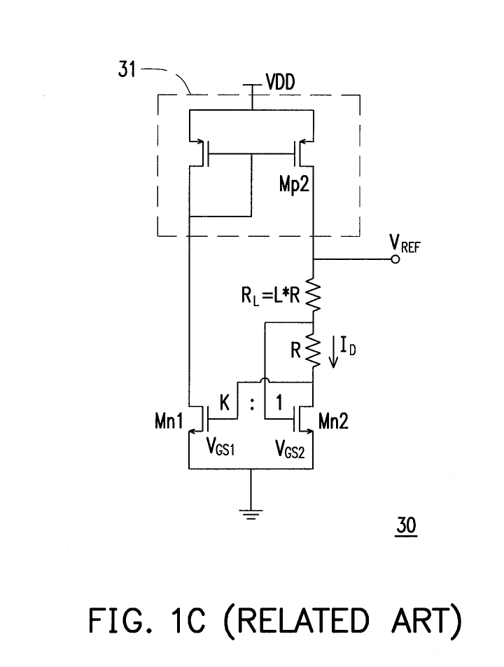

### DETAILED DESCRIPTION OF THE DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

The design mechanism of the disclosure is based on the metal-oxide semiconductor (MOS) transistors as the main elements, the MOS transistors operate in the sub-threshold region, so as to have a gate voltage of the MOS transistors has a voltage having negative temperature coefficient. Accordingly, an excessive layout area occupied by the bipolar junction (BJT) transistors can be avoided. In addition, since there are no current at a gate of the MOS transistors, the amount of current is not affected by the fabrication or any other factors as it may have in the conventional art using BJT transistors, which causes the reference voltage to fluctuate.

According to one of the exemplary embodiments, a reference voltage generator of the embodiment of the disclosure utilizes a current mirror unit having a folded cascode configuration to provide a bias current and a mirror current, which may reduce a system voltage during circuit operation, so as to reduce the power consumption of the whole circuit.

According to the embodiment of the disclosure, the MOS transistors are utilized as an input pair of an operational transconductance amplifier (OTA), and the reference voltage is fed back to the input pair of OTA by a negative feedback, so as to avoid the noise interference generated by the system voltage, and accordingly stabilize the reference voltage.

According to one of the exemplary embodiments, an output stage unit is utilized and configured to latch the reference voltage, and a voltage-to-current conversion circuit is utilized to convert the reference voltage having zero temperature coefficient to a first reference current having zero temperature coefficient. In an exemplary embodiment, the voltage-to-current conversion circuit is constructed by an impedance providing element.

According to one of exemplary embodiments, the reference voltage generator set forth in the embodiment of the disclosure utilizes a voltage boosting circuit to boost the reference voltage to a voltage value that meets the circuit design requirement. In an exemplary embodiment, the voltage boosting circuit is constructed by an impedance providing element. In another exemplary embodiment, the voltage boosting circuit may be a voltage dividing circuit constructed by a plurality of resistors in series.

According to one of exemplary embodiments, the reference voltage generator set forth in the embodiment of the disclosure utilizes a voltage bucking circuit to buck the reference voltage to a voltage value that meets the practical circuit design requirement.

According to exemplary embodiment, the voltage bucking circuit of the embodiment of the disclosure extracts the current from the reference voltage generation unit to the voltage bucking circuit to reduce the current within the reference voltage generator. As a result, a current-resistor drop (IR drop) is reduced, and accordingly the reference voltage may be reduced to a voltage value that meets the circuit design requirement.

According to an exemplary embodiment, a reference voltage generator set forth in the embodiment of the disclosure may integrate the voltage boosting circuit and the voltage bucking circuit in the same reference voltage generator, so as to provide a plurality of reference voltages for selection.

According to one of the exemplary embodiments, the reference voltage generator set forth in the embodiment of disclosure utilizes a temperature compensation unit to compensate a temperature coefficient of the reference voltage, so as to further reduce the effect upon the reference voltage due to the temperature fluctuation.

According to an exemplary embodiment, the temperature compensation unit includes a self-bias current mirror circuit, which is configured to generate current having a positive temperature coefficient. In addition, part of the MOS transistors or all of the MOS transistors in the self-bias current mirror circuit operates in sub-threshold region to generate a gate-source voltage having a negative temperature coefficient. In addition, the impedance providing element is utilized to generate the self-bias current having a positive temperature coefficient.

According to one of the exemplary embodiments, the transistors in the reference voltage generator are all MOS transistors, so that an excessive layout area occupied by BJT transistors can be avoided.

In order to make the content of the disclosure more comprehensible, several embodiments accompanied with figures are described in detail below.

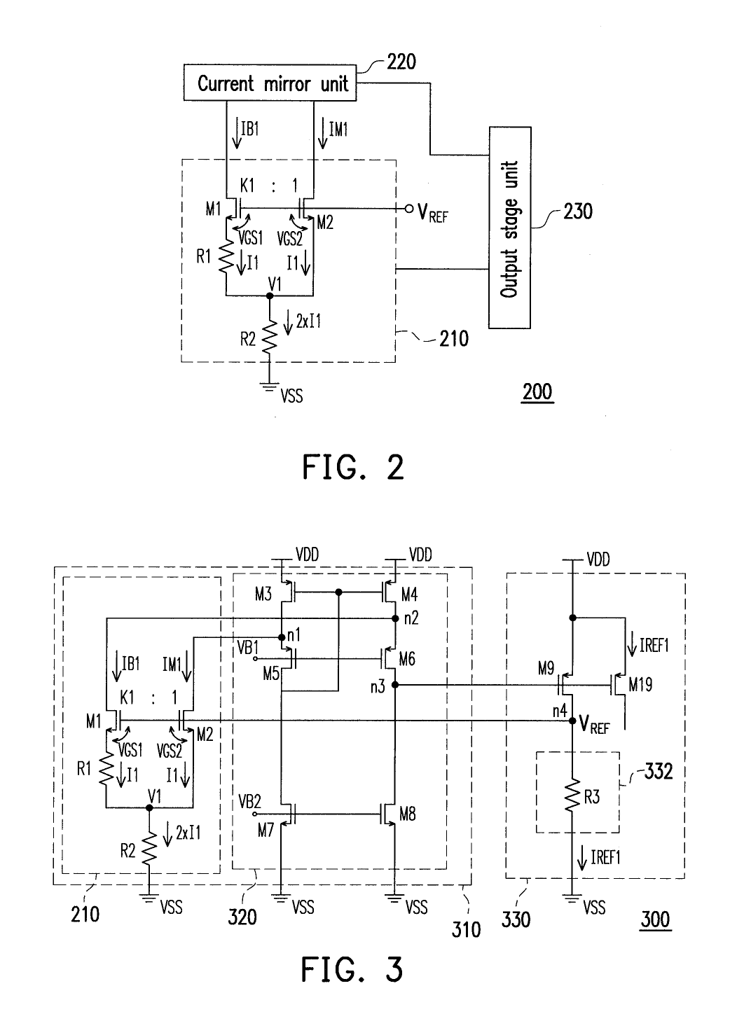

FIG. 2 is a diagram illustrating a reference voltage generator according to an embodiment of the disclosure. With reference to FIG. 2, a reference voltage generator 200 in the present embodiment includes a reference voltage generation unit 210, a current mirror unit 220, and an output stage unit 230. The reference voltage generation unit 210 receives a bias current IB1 and a mirror current IM1 provided by the current minor unit 220, so that the reference voltage generation unit 210 may operates in a circuit operational region that generates a reference voltage V_{REF} having a temperature coefficient that is close to or equal to a zero temperature coefficient. The current minor unit 220 is electrically connected to the reference voltage generation unit 210. The output stage unit 230 is coupled to the reference voltage generation unit 210 and the current mirror unit 220. The output stage unit 230 is configured to latch and to stabilize the reference voltage V_{REF} generated by the reference voltage generation unit 210.

In the embodiment of the disclosure, the reference voltage generation unit 210 includes two MOS transistors M1 and M2 and two impedance providing elements R1 and R2. A first terminal (e.g., a drain) of the MOS transistor M1 is coupled to the current mirror unit 220. A first terminal (e.g., a drain) of the MOS transistor M2 is coupled to the current mirror unit 220, a gate terminal of the MOS transistor M2 is coupled to a gate terminal of the MOS transistor M1, and the common connection of the gate terminals outputs a reference voltage V_{REF}. A width-to-length ratio of the MOS transistor M1 is K1 multiple of a width-to-length ratio of the MOS transistor M2, where K1 is a number greater than 0 and not equal to 1. In an embodiment, the MOS transistor M1 having, for example, a width of 30 and a length of 1, so the width-to-length ratio of the MOS transistor M1 is 30. The MOS transistor M2 having, for example, a width of 20 and a length of 1, so the width-to-length ratio of the MOS transistor M2 is 20. Therefore, K1 is 30/20=1.5.

A first terminal of the impedance providing element R1 is coupled to a second terminal (e.g., a source) of the MOS transistor M1, and a second terminal of the impedance providing element R1 is coupled to a second terminal (e.g., a source) of the MOS transistor M2. A first terminal of the impedance providing element R2 is coupled to a second terminal of the MOS transistor M2, and a second terminal of the impedance providing element R2 is coupled to a ground voltage VSS.

Next, the operation of the reference voltage generation unit 210 is described in the follows. The first terminal of the MOS transistor M1 receives the bias current IB1 provided by the current mirror unit 220, and the bias current IB1 bias the MOS transistor M1 at a sub-threshold region. In the present embodiment, the MOS transistor M1 is an N-type MOS transistor, however, the embodiment is not limited thereto. The MOS transistor M1 that operates at the sub-threshold region generates a gate-source voltage V_{GS1} having a negative temperature coefficient between the gate terminal and the source terminal. As such, an excessive layout area occupied by the BJT transistors may be avoided.

Similarly, the first terminal of the MOS transistor M2 receives the mirror current IM1 provided by the current mirror unit 220, and the mirror current IM1 is generated by the current mirror unit 220 through mirroring the bias current IB1. In addition, the mirror current IM1 bias the MOS transistor M2 in the sub-threshold region. In the present embodiment, the MOS transistor M2 is an N-type MOS transistor, however, the embodiment is not limited thereto. Therefore, the MOS transistor M2 that operates in the sub-threshold region generates a gate-source voltage V_{GS2} having a negative temperature coefficient between the gate terminal and the source terminal of the MOS transistor M2. The negative temperature coefficient refers to a change in a negative direction in response to a change in temperature.

Next, a voltage between two terminals of the impedance providing element R1 is the gate-source voltage VGS2 minus the gate-source voltage VGS1. Hence, a current I1 having a positive temperature coefficient is generated which flows through the impedance providing element R1, such as the equation shown in the following:

I1=(VGS2−VGS1)/R1=V_{T} ln(K1)/R1 (1)

where V_{T} is a thermal voltage. Under a symmetrical circuit topology architecture, the current I1 having a positive temperature coefficient will also flow out of a source of the MOS transistor M2. Afterward, two currents I1 are simultaneously injected into the impedance providing element R2. According to Ohm's law, when current I1 flowing through the impedance providing element R2 is doubled, an IR drop is generated at two terminals of the impedance providing elements R2.

Since the second terminal of the impedance providing elements R2 is coupled to the ground voltage VSS, a voltage V1 is generated at the first terminal of the impedance providing element R1, and the voltage value of the voltage V1 is the double of current value of the current I1 multiple by a resistance of the impedance providing element R2, such as the following equation (2):

V1=2×I1×R2 (2)

Since the current I1 is a current having a positive temperature coefficient, the voltage V1 is a voltage having a positive temperature coefficient. Based on the above description, the reference voltage V_{REF} in FIG. 2 is the gate-source voltage VGS2 having a negative temperature coefficient plus the voltage V1 having a positive temperature coefficient, which may be represented by the following equation (3):

V_{REF}=VGS2+V1=VGS2+V_{T} ln(K1)L (3)

Furthermore, there is a ratio value L between the impedance providing unit R1 and the impedance providing element R2, which may be represented by the following equation (4):

L=2×R2/R1 (4)

According to the aforementioned equations (3) and (4), designer may adjust the ratio value L according to the circuit design requirement or fabrication tolerance, so that the temperature coefficient of the reference voltage V_{REF} is close to or equal to a zero temperature coefficient.

Moreover, since the reference voltage generation unit 210 utilizes the MOS transistors M1 and M2, no base current is generated, whereas the BJT transistor generates a base current in the conventional art. That is, the gate current of the MOS transistors M1 and M2 are zeros. Therefore, the reference voltage generation unit 210 is different from the BJT transistor utilized in the conventional art, where the size of current I1 may be affected by the fabrication tolerance or other factors in the conventional art, which results in fluctuation of the reference voltage V_{REF}.

FIG. 3 is a schematic diagram illustrating the circuit of a reference voltage generator 300 according to an embodiment of the disclosure. With reference to FIG. 3, the reference voltage generator 300 in the present embodiment includes a reference voltage generation unit 210, a current mirror unit 320, and an output stage unit 330. The functions of the current mirror unit 320 and the output stage unit 330 are similar to the functions of the current mirror unit 220 and the output stage unit 230. The current mirror unit 320 is configured to provide a bias current IB1 and a mirror current IM1. The output stage unit 330 is configured to stabilize the reference voltage V_{REF} and generate a reference current IREF1. The current mirror unit 320 includes six transistors M3, M4, M5, M6, M7, and M8. A first terminal of the transistor M3 is coupled to a system voltage VDD, and a second terminal of the transistor M3 is coupled to the first terminal of the MOS transistor M2. A first terminal of the transistor M4 is coupled to the system voltage VDD, a gate terminal of the transistor M4 is coupled to a gate terminal of the transistor M3, and a second terminal of the transistor M4 is coupled to the first terminal of the MOS transistor M1.

A first terminal of the transistor M5 is coupled to a second terminal of the transistor M3, a gate terminal of the transistor M5 receives a bias voltage VB1, and a second terminal of the transistor M5 is coupled to a gate terminal of the transistor M3. A first terminal of the transistor M6 is coupled to a second terminal of the transistor M4, and a gate terminal of the transistor M6 receives a bias voltage VB 1. A first terminal of the transistor M7 is coupled to the second terminal of the transistor M5, a gate terminal of transistor M7 receives a bias voltage VB2, and a second terminal of the transistor M7 is coupled to a ground voltage VSS. A first terminal of the transistor M8 is coupled to the second terminal of the transistor M6, a gate terminal of the transistor M8 receives a bias voltage VB2, and a second terminal of the transistor M8 is coupled to the ground voltage VSS. In the present embodiment, the transistors M3-M6 are p-channel MOS transistors, and the transistors M7-M8 are N-channel MOS transistors. However, the embodiment is not limited thereto.

The output stage unit 330 includes a transistor M9 and a voltage-to-current conversion circuit 332. A first terminal of the transistor M9 is coupled to the system voltage VDD, a gate terminal of the transistor M9 is coupled to the second terminal of the transistor M6, and a second terminal of the transistor M9 is coupled to the gate terminal of the MOS transistor M2. A first terminal of the voltage-to-current conversion circuit 332 receives the reference voltage V_{REF}, and a second terminal of the voltage-to-current conversion circuit 332 is coupled to the ground voltage VSS. The voltage-to-current conversion circuit 332 may be configured to convert the reference voltage V_{REF} to the reference current IREF1. In the present embodiment, transistor M9 is a P-channel MOS transistor, however, the embodiment is not limited thereto.

The current mirror unit 320 in the present embodiment is directly coupled to the reference voltage generation unit 210, such circuit topology architecture forms an operational transconductance amplifier (OTA) 310, and a negative feedback constructed by the OTA 310 and the output stage unit 330 can be configured to stabilize the reference voltage V_{REF}. Since, the reference voltage V_{REF} is directly inputted to an input pair of the OTA 310 (that is, the MOS transistors M1 and M2), when the system voltage VDD is interfered by noise, for example, the voltages at the nodes n1 and n2 is affected, a current value of the current I1 is further affected according to the property of elements, and thus the stability of the reference voltage V_{REF} is also affected. Next, a noise interference signal on the node n3 is transmitted to the gate terminal of the transistor M9 via the negative feedback path. At the time, the transistor M9 is coupled in a common source configuration, so that a noise interference signal having a phase reversal is generated and superimposed to the reference voltage V_{REF} of the node n4, and accordingly the diverged reference voltage V_{REF} is stabilized again. Therefore, the circuit topology architecture constructed by the OTA 310 and output stage unit 330 has a good power supply rejection ratio (PSRR) that is able to reduce the interference of power noise.

Furthermore, the current mirror unit 230 of the present embodiment is coupled to the reference voltage generation unit 210 in a folded cascode current minor configuration, so it is beneficial for reducing the system voltage VDD required during the operation of circuit, so as to reduce the power consumption of whole circuit. In the embodiment of the disclosure, to satisfy the circuit operation, the system voltage VDD should be at least the reference voltage V_{REF} plus an overdrive voltage of the transistor M3 (or transistor M4). Alternatively, the voltage-to-current conversion circuit 332 of the embodiment is an impedance providing element R3, however it is not limited thereto. A first terminal of the impedance providing element R3 receives the reference voltage V_{REF}, and a second terminal of the impedance providing element R3 is coupled to the ground voltage VSS, which may be configured to generate a reference current IREF1. Furthermore, it would be apparent to those skilled in the art that the reference current IREF1 flowing through the transistor M9 can be mirrored to a plurality of circuits or other elements that need the reference current IREF1, and the reference current IREF1 can be adjusted through adjusting the width-to-length ratio or the area ratio. For example, in an embodiment of the disclosure, the output stage unit 330 may further include a transistor M19, which is configured to mirror the reference current IREF1 flowing through the transistor M9 to be a reference current for external circuits. A gate of transistor M19 is coupled to the gate of the transistor M9, and the width-to-length ratio of the transistor M19 equals to the width-to-length ratio of the transistor M9.

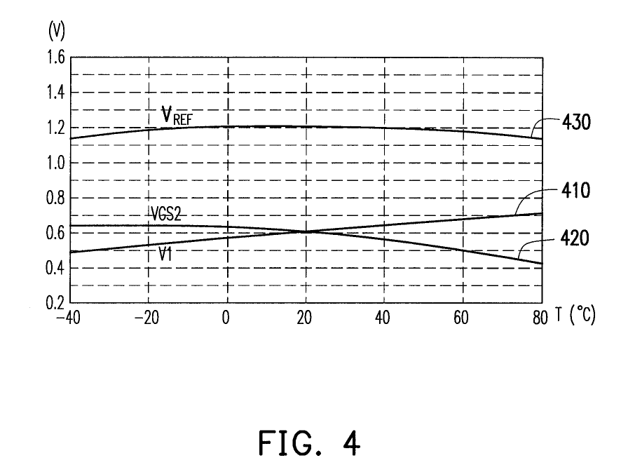

Next, with reference to FIG. 4 at same time, where FIG. 4 is a graphical diagram for the illustration of the reference voltage having temperature coefficient of the embodiment of FIG. 3. The horizontal axis in FIG. 4 denotes temperature in Fahrenheit, and the vertical axis in FIG. 4 denotes voltage in Volts. From the description of the embodiments illustrated in FIGS. 2-3, the reference voltage V_{REF} is the addition of a gate-source voltage VGS2 having a negative temperature coefficient and a voltage V1 having a positive temperature coefficient. In the experimental result of the present embodiment, a curve 420 representing the gate-source voltage VGS2 having a negative coefficient decreases gradually as temperature increases, and a curve 410 representing the gate-source voltage VGS2 having a negative temperature coefficient increases gradually as temperature increases. Therefore, with superposition principle, a curve 430 representing the reference voltage V_{REF} is the superposition (addition) of the curve 420 representing the gate-source voltage VGS2 having a negative temperature coefficient and the curve 410 representing the voltage V1 having a positive temperature coefficient. Therefore, the curve 430 is a curve that is close to or partially equals to a voltage having the zero temperature coefficient. Next, the embodiment of a reference voltage generator having a voltage boosting circuit is described in the following.

It should be noted that the references and partial contents in the aforementioned embodiments are utilizes to describe the following embodiments, where the same references are utilized to represent identical or similar elements, and the description of features having similar contents are omitted. Please refer to the aforementioned embodiments for the description of the part that is omitted, it is not repeated in the following embodiments.

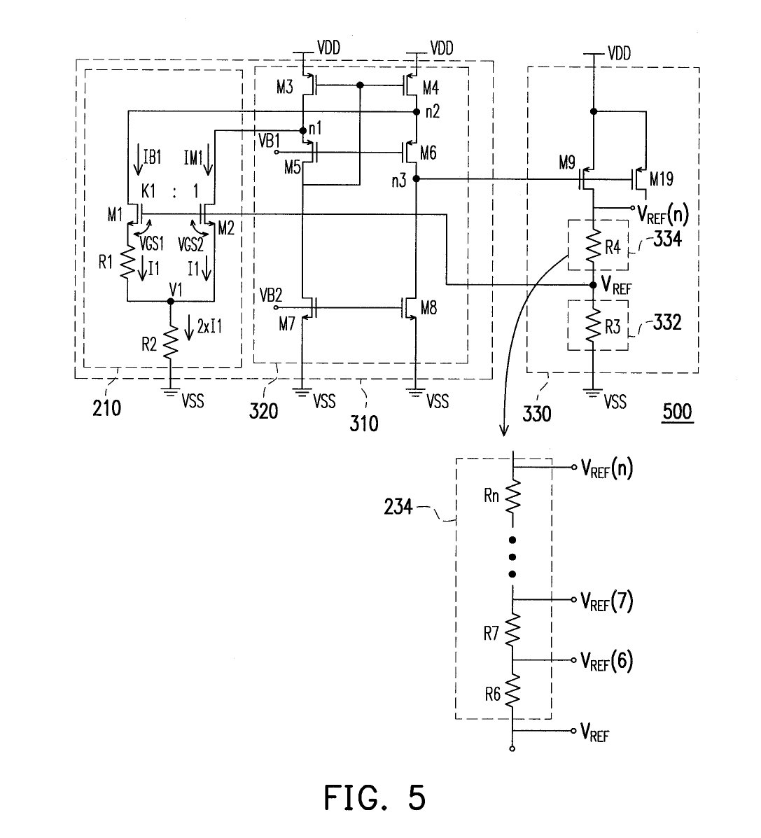

FIG. 5 is a schematic diagram illustrating the reference voltage generator having a voltage boosting circuit. With reference to FIG. 5, the difference between the embodiments illustrated in FIGS. 3 and 5 is that the output stage unit 330 further includes a voltage boosting circuit 334 in the present embodiment. A second terminal of the voltage boosting circuit 334 receives the reference voltage V_{REF}, and a first terminal of the voltage boosting circuit 334 is coupled to the second terminal of the transistor M9. The voltage boosting circuit 334 is configured to boost the reference voltage V_{REF} to a reference voltage V_{REF}(n). In the present embodiment, the voltage boosting circuit 334 is an impedance providing element R4. In other embodiments, the voltage boosting circuit 334 may be any circuit that boosts the reference voltage V_{REF}, it is not limited thereto. A second terminal of the impedance providing element R4 receives the reference voltage V_{REF}, and a first terminal of the impedance providing element R4 is coupled to the second terminal of the transistor M9. In addition, the impedance providing element R4 determines a magnitude of the reference voltage V_{REF} to be boosted. Therefore, the equation of the reference voltage in the reference voltage generator 500 can be modified to the equation (5) in the following. The resistance of the impedance providing element R4 can be adjusted according to the circuit design requirements in order to design the desired reference voltage V_{REF}(n).

V_{REF}(n)=[VGS2+V_{T} ln(K1)L]×((R3+R4)/R3) (5)

In addition, in yet other embodiment of the disclosure, the voltage boosting circuit 334 may be designed with a plurality of impedance providing elements (such as R6-Rn) that are in series connection forming a voltage dividing circuit. According to the circuit design requirement, designer may provide a plurality of reference voltages (such as V_{REF}(6)-V_{REF}(n)), which are already boosted, through adjusting the resistances of each of the impedance providing elements (such as R6-Rn). Furthermore, the reference voltages (such as V_{REF}(6)-V_{REF}(n)) are transmitted to the terminals of a plurality of circuits or other elements.

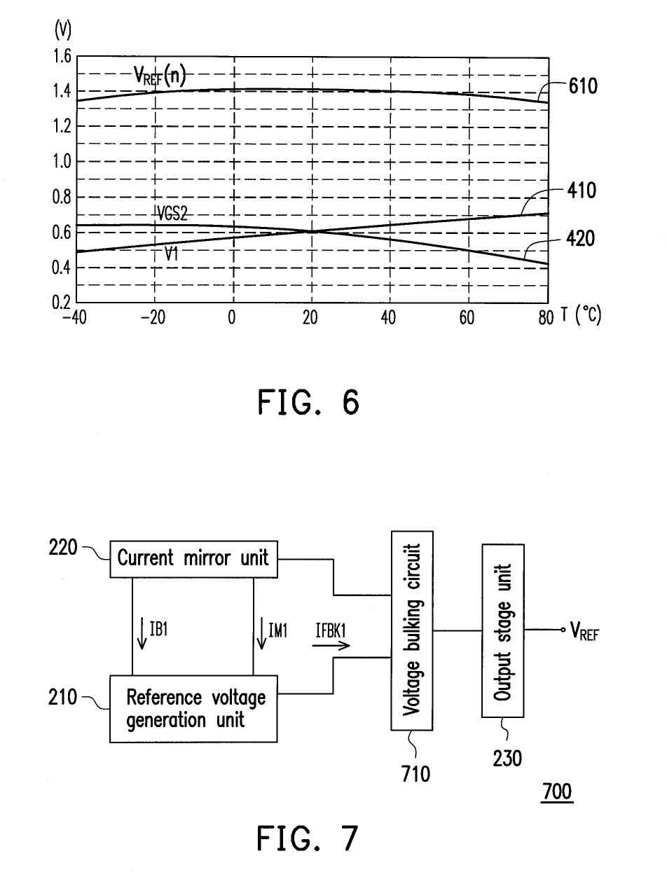

FIG. 6 is a graphical diagram for the illustration of the reference voltage generator having the voltage boosting circuit of the embodiment in FIG. 5. For the convenience of illustration for illustrating the curve result of the present embodiment, please refer to FIGS. 4 and 6. In FIG. 6, the horizontal axis represents temperature in Fahrenheit, and the vertical axis represents voltage in Volts. First, it should noted that there are no changes to a curve 410 of the gate-source voltage VGS2 having a negative temperature coefficient and a curve 420 of the voltage V1 having a positive temperature coefficient. That is, the gate-source voltage VGS2 and the voltage V1 are not affected by the additional voltage boosting circuit 334 in the reference voltage generator 500 of the embodiment of the disclosure. Next, by comparing the curves 430 and 610 in FIG. 4 and FIG. 6, it is apparent that a curve 610 of the reference voltage V_{REF}(n) increases approximately 0.2 volts comparing to the curve 430 of the reference voltage V_{REF}.

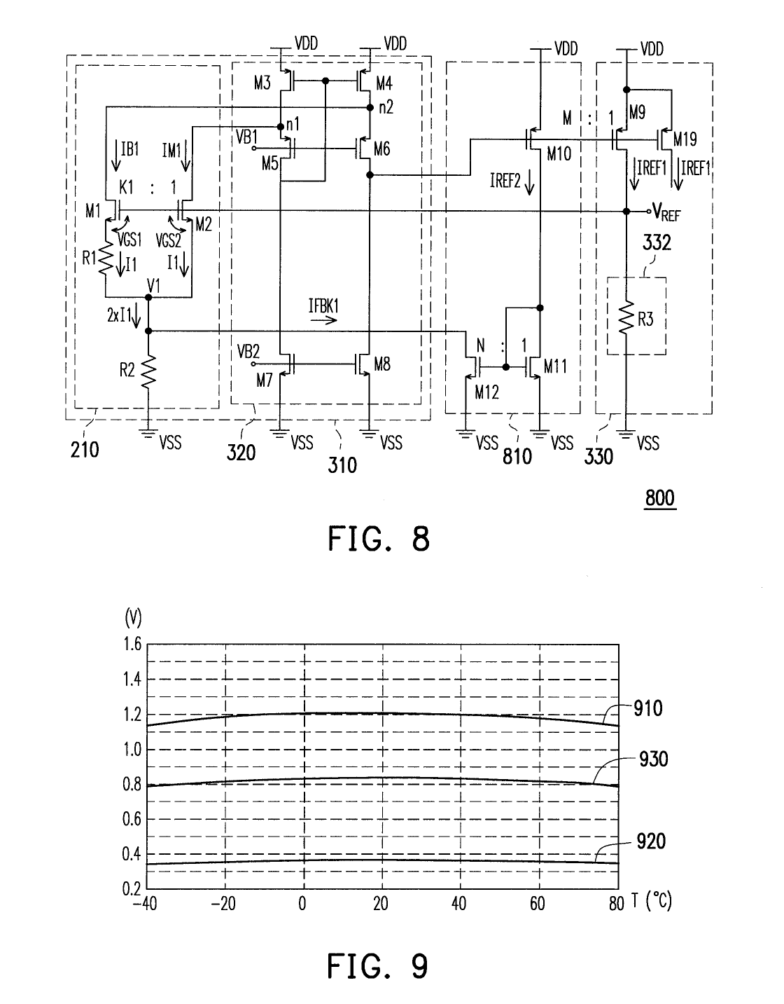

Next, a reference voltage generator having a voltage bucking circuit of another embodiment of the disclosure is illustrated, which may buck the reference voltage V_{REF} of the embodiment in FIG. 2. With reference to FIG. 7, FIG. 7 is a system structural diagram illustrating a reference voltage generator 700 having a voltage bucking circuit 710. The difference between the reference voltage generator 700 and the reference voltage generator 200 is that the reference voltage generator 700 further includes a voltage bucking circuit 710. The voltage bucking circuit 710 is electrically connected between the reference voltage generator 210 and the output stage unit 230. The voltage bucking circuit 710 extracts a portion of the current in the reference voltage generation unit 210 to serve as a feedback current IFBK1 to adjust the reference voltage V_{REF}.

With reference to FIG. 8, FIG. 8 is a circuit diagram illustrating the reference voltage generator having a voltage bucking circuit according to an embodiment of the disclosure. The difference to the embodiment of FIG. 3 is that a reference voltage generator 800 of the present embodiment further includes a voltage bucking circuit 810. The voltage bucking circuit 810 is electrically connected to the reference voltage generation unit 210 and the output stage unit 230, and adjusts the reference voltage VREF according to the feedback current IFBK1, where the feedback current IFBK1 is a portion of current extracted from the reference voltage generation unit 210. The voltage bucking circuit 810 includes a transistor M10, a transistor M11, and a transistor M12. a first terminal of the transistor M10 is coupled to the system voltage VDD, and a gate terminal of the transistor M10 is coupled the gate terminal of the transistor M9. a first terminal of the transistor M11 is coupled to a second terminal of the transistor M10, a second terminal of the transistor M11 is coupled to the ground voltage VSS, and a gate terminal of the transistor M11 is coupled to a second terminal of the transistor M10. a first terminal of the transistor M12 is coupled to a first terminal of the impedance providing element R2, a second terminal of the transistor M12 is coupled to the ground voltage VSS, and a gate terminal of the transistor M12 is coupled to the gate terminal of the transistor M11. The transistors of the present embodiment are N-channel MOS transistors, however it is not limited thereto. The operation of the reference voltage generator 800 having the voltage bucking circuit 810 is further explained in the transistor level in the follows.

In the present embodiment, a width-to-length ratio of the transistor M10 is M times of a width-to-length ratio of the transistor M9, where M is a number greater than 0 and the gates and sources of the transistors M9 and M10 have the same electrical potential, and the transistor M9 is assumed to be in active region while normal operation. In an embodiment, for example, the transistor M10 has a width of 30 and length of 1, so the width-to-length ratio is 30. In addition, the transistor M9 has a width of 20 and length of 1, then the width-to-length ratio is 20. Hence, M is 30/20=1.5.

Under the circumstance that the channel length modulation effect is not considered, the transistor M10 mirrors an M multiple of the reference current IREF1 flowing through the transistor M9 as a reference current IREF2. In other words, the current value of the reference current IREF2 is M multiples of the current value of the reference current IREF1, which is shown in the equation (6) follows. Moreover, the reference current IREF2 and reference current IREF1 have the same temperature coefficients.

IREF2=M×IREF1 (6)

The reference current IREF2 also flows through the transistor M11 due to the wiring of the circuit. In the present embodiment, a width-to-length ratio of the transistor M12 is N times of a width-to-length ratio of the transistor M11, where N is a number greater than 0, Since the gate and source of the transistors M10 and M11 are in the same electrical potential, and the transistor M11 bias in active region under the normal operation, under the circumstance that the channel length modulation effect is not considered, the transistor M12 mirrors N times of the reference current IREF2 flowing through the transistor M11 as the feedback current IFBK1. In other words, the feedback current IFBK1 is M multiplied by N times of reference current IREF1, such as equation (7) shown in the following.

IFBK1=M×N×IREF1 (7)

Further, the feedback current IFBK1 is a portion of the double of the current I1 in the reference voltage generation unit 210 that is extracted by the voltage bucking circuit 810, so that current flowing through the impedance providing elements R2 decreases. When the current flowing through the impedance providing element R2 decreases, the voltage at two ends of the impedance element R2 also decreases. Since the second terminal of the impedance providing element R2 is coupled to the ground voltage VSS, the voltage drop reduced at two terminals of the impedance providing unit R2 is reflected at the electrical potential of the first terminal of the impedance providing element R2 (that is, the voltage V1), and the voltage drop is IFBK1×R2. Referring back to the equation (3), the reference voltage VREF is the addition of the gate-source voltage VGS2 and the voltage V1, so the reference voltage reduces IFBK1×R2, and the final reference voltage VREF is modified as the equation (8) shown in the following.

V_{REF}=[VGS2+V_{T} ln(K1)L]×[R3/(R3+M×N×R2)] (8)

With reference to equations (7) and (8), designers may select the M and N appropriately according to the circuit design requirement or fabrication tolerance after selecting the impedance providing elements R2 and R3, so as to further determine a magnitude of the voltage drop for the reference voltage V_{REF}.

Hereinafter, the experimental result of the exemplary embodiment is illustrated with a graph.

FIG. 9 is a graphical diagram illustrating the reference voltage generator having the voltage bucking circuit according to the embodiment in FIG. 8. With reference to FIG. 9, the horizontal axis represents temperature in Fahrenheit, and the vertical axis represents voltage in Volts. A curve 910 represents the reference voltage before bucking, a curve 930 represents the reference voltage after bucking, and a curve 920 represents the amount of the voltage drop (that is, IFBK1×R2). From FIG. 9, the dropping rate of the curve 910 almost corresponds to the voltage value of the curve 920. That is, by applying superposition principle, the curve 930 equals to the curve 910 subtracting the curve 920. This is consistent with the mathematical formula shown in equation (8), which corresponds to the description of the operation of the embodiment in FIG. 8.

Hereinafter, another embodiment of the disclosure is illustrated by diagram, that is, a voltage reference generator having temperature compensation unit. Since, in one of the exemplary embodiments, the transistors are all MOS transistors, the temperature characteristic of the reference voltage generator may be not be as good as the BJT transistor in the conventional art. In addition, the temperature coefficient is easily drifted due to the fabrication tolerance. Therefore, another embodiment of the disclosure is set forth, namely, a reference voltage generator having a temperature compensation unit, so as to provide a better handling of the aforementioned issue.

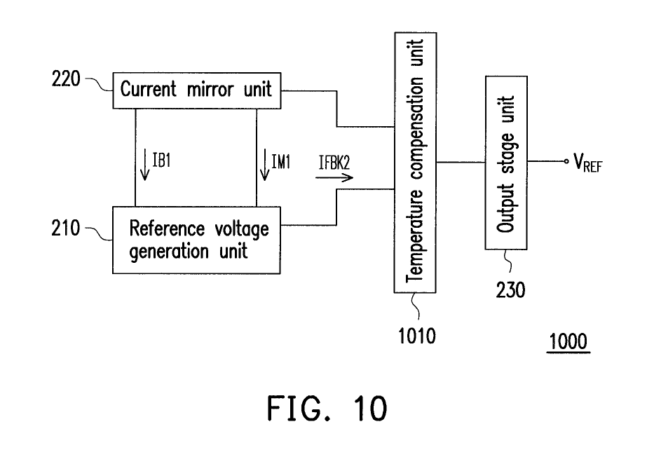

In order to make the present embodiment comprehensible, referring to FIG. 10. FIG. 10 is a system structural diagram illustrating a reference voltage generator 1000 having a temperature compensation unit 1010 according to an embodiment of the disclosure. The difference between the present embodiment and the embodiment of FIG. 2 is that the reference voltage generator 1000 further includes a temperature compensation unit 1010. The temperature compensation unit 1010 is coupled between the reference voltage generation unit 210 and the output stage unit 230, which is configured to compensate the temperature coefficient of the reference voltage V_{REF}.

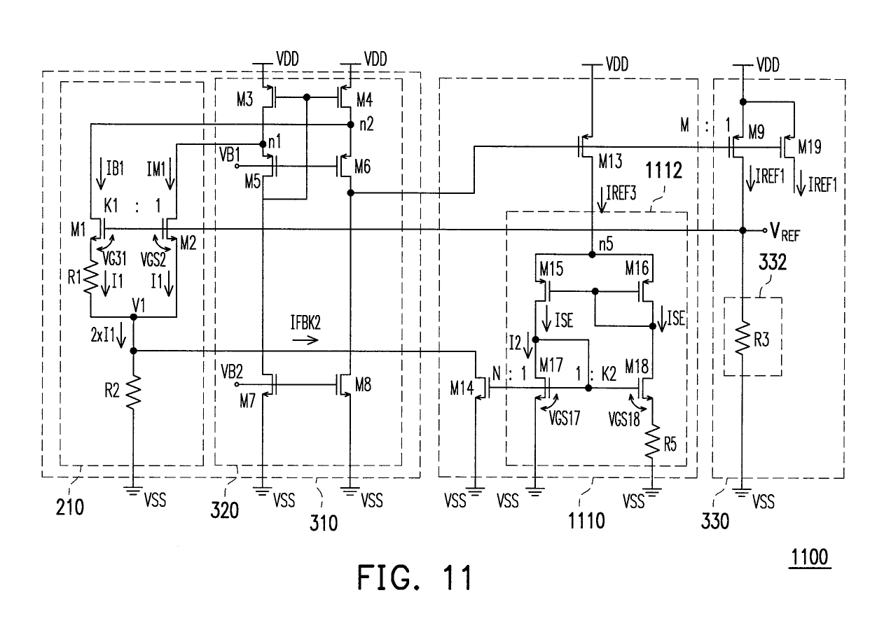

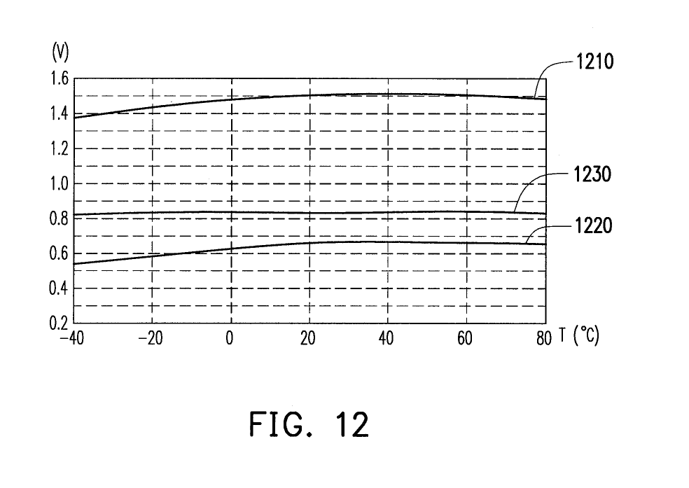

With reference to FIG. 11, FIG. 11 is a circuit diagram illustrating a reference voltage generator 1100 having a temperature compensation unit 1110 according to an embodiment of the disclosure. The difference between the reference voltage generator 1100 and the reference voltage generator 300 of FIG. 3 is that the reference voltage generator 110 further includes a temperature compensation unit 1110. The temperature compensation unit 1110 is coupled between the reference voltage generation unit 210 and the output stage, and is configure to compensate the temperature coefficient of the reference voltage V_{REF}. The temperature compensation unit 1110 includes a transistor M13, a transistor M14, and a self-bias current mirror circuit 1112. A first terminal of the transistor M13 is coupled to the system voltage VDD, a gate terminal of the transistor M13 is coupled to the gate terminal of the transistor M9. The self-bias current mirror circuit 1112 is electrically connected to a second terminal of the transistor M13. A first terminal of the transistor M14 is coupled to the first terminal of the impedance providing element R2, a second terminal of the transistor M14 is coupled to the ground voltage VSS, and a gate terminal of the transistor M14 is electrically connected to the self-bias current mirror circuit 1112.

The self-bias current mirror circuit 1112 includes a transistor M15, a transistor M16, a transistor M17, a transistor M18, and an impedance providing element R5. A first terminal of the transistor M15 is coupled to the second terminal of the transistor M13. A first terminal of the transistor M16 is coupled a first terminal of the transistor M15, and a gate terminal of the transistor M16 is coupled to a second terminal of the transistor M16 and a gate terminal of the transistor M15. A first terminal of the transistor M17 is coupled to the second terminal of the transistor M15 and a gate terminal of the transistor M17. A second terminal of the transistor M17 is coupled to the ground voltage VSS. A first terminal of the transistor M18 is coupled to the second terminal of the transistor M16, a gate terminal of the transistor M18 is coupled to the gate terminal of the transistor M17. A first terminal of the impedance providing element R5 is coupled to a second terminal of the transistor M18, and a second terminal of the impedance providing element R5 is coupled to the ground voltage VSS. In the present embodiment, the transistors M15-M18 are N-channel MOS transistors, however it is not limited thereto.

In the self-bias current mirror circuit 1112, a width-to-length ratio of the transistor M18 is a K2 multiple of a width-to-length ratio of the transistor M17, where K2 is a number greater than 0 and not equal to 1. In an embodiment, for example, the transistor M18 has a width of 30 and a length of 1, thus the width-to-length ratio is 30. The transistor M17 has a width of 20 and a length of 1, so the width-to-length ratio is 20. Therefore, M equals to 30/20=1.5. In addition, in the present embodiment, the transistors M17 and M18 are biased in the sub-threshold region, which is mainly configured to generate a gate-source voltage VGS17 having a negative coefficient and a gate-source voltage eVGS18 having a negative temperature coefficient. Next, a voltage difference (VGS17−VGS18) is formed between the two terminals of the impedance providing element R5, therefore, a self-bias current ISE having a positive temperature coefficient is generated by the impedance providing element R5. Currents flowing through the transistors M15-M18 are self-bias current ISE having positive temperature coefficient due to the circuit symmetry.

In the present embodiment the width-to-length ratio of the transistor M9 is M multiple of the width-to-length ratio, where M is a number greater than 0. The gates and sources of the transistors M9 and M13 have identical electrical potential, and the transistor M9 is assumed to be biased in the active region while normal operation. Therefore, under the circumstance that the channel length modulation effect is not been considered, the transistor M13 mirrors M multiple of the reference current IREF1 flowing through the transistor M9 as a reference current IREF3. In other words, the current value of the reference current IREF3 is M multiple of the current value of the reference current IREF1, which is illustrated in the following equation (9):

IREF3=M×IREF1 (9)

It should be noted that the reference current IREF3 and the reference current IREF1 have identical temperature coefficient, namely, having a current that is close to or equal to zero temperature coefficient.

Next, the self-bias current mirror circuit 1112 generates a self-bias current ISE. In the present embodiment, the bias current ISE is a current having a positive temperature coefficient, which has different temperature coefficient as the reference current IREF3 having temperature coefficient that is close to or equal to zero temperature coefficient. In the present embodiment, since currents flowing through transistors M15-M18 are the same as the self-bias current ISE, and the current path at the node n5 is divided into two current paths, a current value of a current I2 is determined based on a lower value between the self-bias current ISE and a half of the reference current IREF3, which is represented by the equation (10) in the following:

I2=min(ISE,IREF3/2) (10)

The transistor M14 mirrors the current I2 to serve as a feedback current IFBK2, and the feedback current IFBK2 is a portion of the double of the current I1 extracted by the temperature compensation unit 1110 from the reference voltage generation unit 210. In an embodiment, a width-to-length ratio of the transistor M14 is N multiple of the width-to-length ratio of the transistor M17, therefore, N multiple of the current I2 is mirror as the feedback current IFBK2, where N is a number greater than 0. In an embodiment, for example, the transistor M18 has a width of 30 and a length of 1, so the width-to-length ratio is 40. The transistor M17 has a width of 20 and a length of 1, so the width-to-length ratio is 20. Therefore, M is 30/20=1.5.

Nevertheless, similar to the voltage bucking circuit of the embodiment in FIG. 8, the means of draining decreases the current that flows through the impedance providing element R2 of the embodiment in FIG. 3. Similarly, reference voltage V_{REF} will reduce to IFBK2×R2. The difference to the embodiment in FIG. 8 is that the feedback current IFBK2 of the present embodiment may be a mirror current of N multiple of the self-bias current ISE having a positive temperature coefficient, or mirror current of N multiple of a half of the reference current IREF3 having a temperature coefficient that is close to or equal to zero temperature coefficient. The difference in different temperature coefficient can be compensated to the reference voltage VREF, where the temperature coefficient may drift due to the fabrication tolerance or other factors. The compensation of the temperature coefficient of the reference voltage generator 1100 is further illustrated in the following.

Referring to the following equations (11)-(12),

IFBK2=N×(V_{T} ln(K2))/R2,T<TC (11)

IFBK2=N×M×(V_{REF}/2R3),T>TC (12)

where TC is a temperature cross point, and T represents temperature. In the present embodiment, the temperature coefficient curves of the reference current IREF3 and the self-bias current ISE have a temperature cross point TC. Therefore, when temperature T is less than the temperature cross point TC, the current I2 is the self-bias current ISE having a positive temperature coefficient, and the feedback current IFBK2 is N multiple of the current I2 which is mirrored by transistor M14. When temperature T is greater than the temperature cross point TC, the current I2 is half of the reference current IREF3 having a temperature coefficient that is close to or equal to zero temperature coefficient, and the feedback current IFBK2 is N multiple of the current I2 which is mirrored by transistor M14. Therefore, in the present embodiment, the property of the temperature coefficient of the current I2 can be determined according to the correlation between the temperature T and temperature cross point TC, so as to determine the property of the temperature coefficient of the feedback current IFBK2.

Next, with reference to the following equations (13)-(15):

V_{REF}=VGS2+(2×I1−IFBK2)×R2 (13)

V_{REF}=VGS2+V_{T}(R2/R1)[(2−N)ln(K1)],T<TC (14)

V_{REF}=[VGS2+2V_{T}(R2/R1)ln(K1)]×(2R3/(2R3+M×N×R2)),T>TC (15)

The questions (11)-(12) are respectively plugged into the equation (13), and assume that K1=K2 and R1=R2, which results in the mathematical formula of the equations (14)-(15). In other words, when the temperature T is less than the temperature cross point TC, the 2 multiple of current I1 subtract the feedback current IFBK2 having a positive temperature coefficient, so that the temperature coefficient of the reference voltage VREF is compensated. As illustrated with equation (13), the reference voltage VREF can be close to or equal to zero temperature coefficient through adjusting a ratio between the impedance providing elements R2 and R1. It should be apparent from the equation (14) that, in the present embodiment, N can not equal to 2 in addition to a condition of a number greater than 0. Otherwise, V_{REF}=VGS2 in equation (14), in other words, the reference voltage V_{REF} will have a negative temperature coefficient.

When temperature is greater than the temperature cross point TC, the double of current I1 will subtract the feedback current IFBK2 having a temperature coefficient that is close to or equal to zero temperature coefficient, so as to compensate the temperature coefficient of the reference voltage VREF. As illustrated in equation (15), the reference voltage VREF may be adjusted so it is close to or equal to zero temperature coefficient through adjusting the ratio between the impedance providing elements R2 and R1. The experimental result of the present embodiment is illustrated by graphical diagram in the following.

In the following, another graphical diagram is utilized to illustrate the experimental result of the reference voltage generator 1100 having the temperature compensation unit 1110 in the present embodiment.

FIG. 12 is a graphical diagram illustrating the reference voltage generator having the temperature compensation unit of the embodiment in FIG. 11. With reference to FIG. 12, the horizontal axis represents temperature in Fahrenheit, and the vertical axis represents voltage in Volts. A curve 1210 represents the reference voltage before compensation, a curve 1230 represents the reference voltage after compensation, a curve 1220 represents the compensation for the reference voltage (the physical quantity is IFBK1×R2). From FIG. 12, when the temperature T is less than the temperature cross point TC, the curve 1220 exhibits a trend of a positive temperature coefficient. When the temperature is greater than the temperature cross point TC, the curve 1220 exhibits a trend that is close to or equal to the zero temperature coefficient. Nevertheless, these two trends correspond to the curve 1210 of the reference voltage that is affected by the fabrication or other factors.

Further, when the temperature T is less than the temperature cross point TC, the curve 1210 and the curve 1220 have the characteristic of positive temperature coefficient. That is, as temperature increases, the rates of increase of two curves are almost identical. When the temperature T is greater than the temperature cross point TC, the curve 1210 and the curve 1220 have the characteristic of having close to or equal to the zero temperature coefficient, that is, as the temperature T increases, the rates of change of two curves (i.e., 1210 and 1220) are almost identical. Furthermore, by superposition principle, the curve 1230 equals to the subtraction of the curve 1210 from curve 1220, so the curve 1230 is close to the horizontal line, that is, the overall curve 1230 is a curve that is close to or equal to the zero temperature coefficient. Therefore, through the above mechanism, when the temperature is less or greater then the temperature cross point TC after the temperature compensation of the reference voltage, the reference voltage will not generate a corresponding changes in response to the changes with the temperature T. That is, the reference voltage generator of the present embodiment may generate a reference voltage that has no correlation to the temperature.

The implementation of the application is not limited to the above exemplary embodiments. It would be apparent to those skilled in the art that various modification and variations can be made according to the above descriptions.

In summary, the embodiment of the disclosure set forth the reference voltage generator having at the following advantages. The embodiment of the disclosure utilizes a first MOS transistor that is biased in the sub-threshold region, and a second MOS transistor that is biased in the sub-threshold region, so as to generate the first and second gate-source voltage having negative temperature coefficients. Additionally, the first and the second gate-source voltage generate a first current having a positive temperature coefficient with the voltage across the first impedance providing element, and the second impedance providing element is utilized to generate a first voltage having a positive temperature coefficient at the first terminal of the second impedance providing element. As a result, the required reference voltage equals to the addition of the first voltage and a second gate-source voltage. Under the circuit architecture that utilizes MOS transistors as main components, large layout area of the BJT transistors may be avoided.

Additionally, in an embodiment, the reference voltage generator further has a voltage boosting circuit for enhancing the reference voltage, and in another embodiment, it may utilize resistors in serial connection to form a voltage dividing circuit so as to provide a plurality of reference voltage to meet the design requirement of each circuit block or element.

Furthermore, in yet other embodiment, the reference voltage generator further includes a voltage bucking circuit that is able to buck the reference voltage to meet the circuit design requirement.

At last, in order to overcome drift effect on the temperature coefficient of the reference voltage due to the characteristic of the MOS transistor and fabrication tolerance, another embodiment of the disclosure further provides a temperature compensation unit, so that the temperature coefficient of the reference voltage is not affected by the fabrication tolerance and the characteristic of the elements.

Although the present disclosure has been described with reference to the above embodiments, however, the present disclosure is not limited thereto. It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A reference voltage generator, comprising:
a reference voltage generation unit, receiving a first bias voltage current and a first mirror current, and configured to generate a reference voltage, wherein the reference voltage generation unit comprises:
a first metal-oxide semiconductor (MOS) transistor, having a first terminal receiving the first bias voltage current, wherein the first MOS transistor operates in a sub-threshold region to generate a first gate-source voltage having a negative temperature coefficient;
a second MOS transistor, having a first terminal receiving the first mirror current, and a gate terminal coupled to a gate terminal of the first MOS transistor, wherein the second MOS transistor operates in a sub-threshold region to generate a second gate-source voltage having a negative temperature coefficient, and a width-to-length ratio of the first MOS transistor is a K1 multiple of a width-to-length ratio of the second MOS transistor, wherein K1 is a number greater than 0 and not equal to 1;
a first impedance providing element, having a first terminal coupled to a second terminal of the first MOS transistor and a second terminal coupled to a second terminal of the second MOS transistor, and configured to generate a first current having a positive temperature coefficient; and
a second impedance providing element, having a first terminal coupled to the second terminal of the second MOS transistor and a second terminal coupled to a ground voltage, and configured to generate a first voltage having a positive temperature coefficient at the first terminal of the second impedance providing element,
wherein the reference voltage equals to the second gate-source voltage plus the first voltage.

2. The reference voltage generator as claimed in claim 1, further comprising a current minor unit, electrically connected to the reference voltage generation unit, and the current mirror unit configured to provide the first bias current and the first mirror current, wherein the current mirror unit mirrors the first bias voltage current to generate the first mirror current.

3. The reference voltage generator as claimed in claim 2, wherein the current mirror unit comprises:
a third transistor, having a first terminal coupled to a system voltage, and a second terminal coupled to the first terminal of the second MOS transistor;
a fourth transistor, having a first terminal coupled to the system voltage, a gate terminal coupled to a gate terminal of the third transistor, and a second terminal coupled to the first terminal of the first MOS transistor;
a fifth transistor, having a first terminal coupled to the second terminal of the third transistor, a gate terminal receiving a first bias voltage, and a second terminal coupled to the gate terminal of the third transistor;
a sixth transistor, having a first terminal coupled to the second terminal of the fourth transistor, and a gate terminal receiving the first bias voltage;
a seventh transistor, having a first terminal coupled to the second terminal of the fifth transistor, a gate terminal receiving a second bias voltage, and a second terminal coupled to the ground voltage; and
an eighth transistor, having a first terminal coupled to a second terminal of the sixth transistor, a gate terminal receiving the second bias voltage, and a second terminal coupled to the ground voltage.

4. The reference voltage generator as claimed in claim 1, further comprising an output stage unit, coupled to the reference voltage generation unit and the current mirror unit, and the output stage unit configured to generate a first reference current.

5. The reference voltage generator as claimed in claim 4, wherein the output stage unit comprises:
a ninth transistor, having a first terminal coupled to the system voltage, a gate terminal coupled to the second terminal of the sixth transistor, a second terminal coupled to the gate terminal the second MOS transistor, and configured to stabilize the reference voltage; and
a voltage-to-current conversion circuit, having a first terminal receiving the reference voltage, a second terminal coupled to the ground voltage, and the voltage-to-current conversion circuit configured to convert the reference voltage into the first reference current.

6. The reference voltage generator as claimed in claim 5, wherein the voltage-to-current conversion circuit is a third impedance providing element, having a first terminal receiving the reference voltage, a second terminal coupled to the ground voltage, and configured to generate the first reference current.

7. The reference voltage generator as claimed in claim 4, wherein the output stage unit further comprises a voltage boosting circuit, having a second terminal receiving the reference voltage and a first terminal coupled to the second terminal of the ninth transistor, and configured to boost the reference voltage to a second reference voltage.

8. The reference voltage generator as claimed in claim 5, wherein the voltage boosting circuit is a fourth impedance providing element, having a second terminal receiving the reference voltage, and a first terminal coupled to the second terminal of the ninth transistor, wherein an impedance value of the fourth impedance providing element determines a magnitude of the reference voltage to be boosted.

9. The reference voltage generator as claimed in claim 4, further comprising a voltage bucking circuit, electrically connected between the reference voltage generation unit and the output stage unit, and bucking the reference voltage by extracting a portion of the first current in the reference voltage generation unit to serve as a first feedback current.

10. The reference voltage generator as claimed in claim 9, wherein the voltage bucking circuit comprises:
a tenth transistor, having a first terminal coupled to the system voltage, and a gate terminal coupled to the gate terminal of the ninth transistor, wherein a width-to-length ratio of the tenth transistor is an M multiple of a width-to-length ratio of the ninth transistor, the tenth transistor is configured to mirror an M multiple of the first reference current to generate a second reference current, wherein M is a number greater than 0, and the first reference current and the second reference current have the same temperature coefficient;
an eleventh transistor, having a first terminal coupled to a second terminal of the tenth transistor, a second terminal coupled to the ground voltage, and a gate terminal coupled to a second terminal of the tenth transistor; and
a twelfth transistor, having a first terminal coupled to the first terminal of the second impedance providing element, a second terminal coupled to the ground voltage, and a gate terminal coupled to the gate terminal of the eleventh transistor, wherein a width-to-length ratio of the twelfth transistor is an N multiple of a width-to-length of the eleventh transistor, the twelfth transistor is configured to mirror an N multiple of the second reference current to generate the first feedback current, wherein the first feedback current is a portion of a double of the first current extracted by the twelfth transistor, and N is a number greater than 0.

11. The reference voltage generator as claimed in claim 4, further comprising a temperature compensation unit, coupled between the reference voltage generation unit and the output stage unit, and configured to compensate the temperature coefficient of the reference voltage.

12. The reference voltage generator as claimed in claim 11, wherein the temperature compensation unit comprises:
a thirteenth transistor, having a first terminal coupled to the system voltage, and a gate terminal coupled to the gate terminal of the ninth transistor, wherein a width-to-length of the thirteenth transistor is an M multiple of a width-to-length ratio of the ninth transistor, and the thirteenth transistor is configured to mirror an M multiple of the first reference current to generate a third reference current, wherein M is a number greater than 0; and
a self-bias current mirror circuit, configured to generate a self-bias current having a positive temperature coefficient, and electrically connected to a second terminal of the thirteenth transistor, wherein a current value of a second current is determined based on a lower value between the self-bias current and a half of the third reference current,
wherein the first reference current and the third reference current have the same temperature coefficient, and the third reference current and the self-bias current have different temperature coefficients.

13. The reference voltage generator as claimed in claim 12, wherein the temperature compensation unit further comprises:
a fourteenth transistor, having a first terminal coupled to the first terminal of the second impedance providing element, a second terminal coupled to the ground voltage, and a gate terminal electrically connected to the self-bias current mirror circuit, wherein the fourteenth transistor mirrors the second current to serve as the second feedback current, and the second feedback current is a portion of a double of the first current extracted by the fourteenth transistor,
wherein a temperature coefficient curve of the third reference current and the self-bias current has a temperature cross point, when the temperature is less than the temperature cross point, the second current is the self-bias current, and when temperature is greater than the temperature cross point, the second current is a half of the third reference current.

14. The reference voltage generator as claimed in claim 12, wherein the self-bias current mirror circuit comprises:
a fifteenth transistor, having a first terminal coupled to the second terminal of the thirteenth transistor;
a sixteenth transistor, having a first terminal coupled to the first terminal of the fifteenth transistor, and a gate terminal coupled to a second terminal of the sixteenth transistor and a gate terminal of the fifteenth transistor;
a seventeenth transistor, having a first terminal coupled to a second terminal of the fifteenth transistor and a gate terminal of the seventeenth transistor, and a second terminal coupled to the ground voltage, wherein a width-to-length ratio of the fourteenth transistor is an N multiple of a width-to-length ratio of the seventeenth transistor, and the seventeenth transistor is configured to mirror an N multiple of the second current to serve as the second feedback current, wherein N is a number and greater than 0;
an eighteenth transistor, having a first terminal coupled to the second terminal of the sixteenth transistor, and a gate terminal coupled to a gate terminal of the seventeenth transistor, wherein a width-to-length ratio of the eighteenth transistor is a K2 multiple of a width-to-length ratio of the seventeenth transistor, and K2 is a number and greater than 0 and not equal to 1; and
a fifth impedance providing element, having a first terminal coupled to a second terminal of the eighteenth transistor, and a second terminal coupled to the ground voltage,
wherein the seventeenth and the eighteenth transistors operate in the sub-threshold region to generate a seventeenth gate-source voltage having a negative temperature coefficient and an eighteenth gate-source voltage having a negative temperature coefficient, and the fifth impedance providing element is configured to generate the self-bias current having a positive temperature coefficient.
